(19) United States
(12) Patent Application Publication
(10) Pub. No.: US 2017/0135502 A1
(43) Pub. Date: May 18, 2017

(54) DISPLAY AND STORAGE BOTTLE CLIP FOR FINGERNAIL LACQUER BOTTLES

(71) Applicant: Nam Thanh Nguyen, Torrance, CA (US)

(72) Inventor: Nam Thanh Nguyen, Torrance, CA (US)

(21) Appl. No.: 14/944,764

(22) Filed: Nov. 18, 2015

(51) Int. Cl. A47F 7/28; B65D 61/00; F16B 2/22

(52) U.S. Cl. CPC A47F 7/28; F16B 2/22; B65D 61/00

(57) ABSTRACT

A device and method for the storage and display of dual fingernail lacquer bottles, which uses resilient flexible arms to grasp the bottles. Each clip has two or more resilient arms having a frontal opening which permit the placement of a bottle, such as a fingernail lacquer or treatment bottle, between the resilient arms. The resilient arms provide a tab for alignment of the fingernail lacquer bottles and catches for attachment of an informational card to the device. The resilient flexible arms utilize friction and compressive forces to grasp the bottle, with each resilient arm being made of a flexible material used to grasp the exterior of a bottle.

### CROSS REFERENCE OF RELATED APPLICATION

Not Applicable.

### BACKGROUND OF THE INVENTION

### Prior Art

The following is a tabulation of some prior art that presently appears relevant:

### U.S. PATENT DOCUMENTS

| Patent Number | Kind Code | Issue Date | Patentee |
|---|---|---|---|
| D 628,746 | S | 2010 Dec. 7 | Peta |
| 7,185,452 | B2 | 2007 Mar. 6 | Brown |
| 7,147,100 | B1 | 2006 Dec. 12 | Borg |
| 6,755,380 | B2 | 2004 Jun. 29 | Pace |
| 6,685,147 | B1 | 2004 Feb. 3 | Ma |
| 5,772,163 | A | 1998 Jun. 30 | Young |
| 4,320,832 | A | 1982 Mar. 23 | Edstrom |
| 3,404,774 | A | 1968 Oct. 8 | Levine |
| D 326,606 | | 1992 Jun. 2 | Green |
| D 259,252 | | 1981 May 19 | Acker |

### U.S. PATENT APPLICATION PUBLICATIONS

| Publication No. | Kind Code | Publ. Date | Applicant |
|---|---|---|---|
| 20150102195 | A | 2015 Apr. 16 | Mah |

### FIELD OF THE INVENTION

The invention relates to an apparatus for storage and display of bottles and, more specifically, to an apparatus for storage and display of a plurality of liquid filled bottles or the like.

### DESCRIPTION OF THE RELATED ART

Often liquids, such as fingernail polish and treatments, are sold at the wholesale and retail levels packaged in containers of varying shapes and sizes. Currently, there are several ways to hold fingernail polish bottles for application as well as various bottle holding and displaying devices. These range in use from those that hold a single fingernail polish bottle for application to those that display multiple bottles.

Some devices are used to hold a single fingernail polish bottle for application purposes (U.S. Pat. Nos. 6,755,380, 6,685,147 & 5,772,163; U.S. Design Pat. No. 628,746; and U.S. Pat. App. No. 20150102195). These devices merely hold a single bottle of fingernail polish, or hold and tilt a single bottle of fingernail polish for purposes of application; the polish bottle is then closed and returned to the shelf These devices are not used for storage or display of the fingernail polish bottle.

There are devices designed to hold a bottle for display or for carrying purposes. These devices include: (1) a clear plastic tab that is attached to a single fingernail polish bottle neck of the bottle and is secured by the cap; (2) a device that is merely a clear form fitted outer shell encapsulating the bottle, which is then secured to an informative card (U.S. Pat. No. 3,404,774; and U.S. Design Pat. Nos. 326,606 and 259,252); and (3) a holder used for carrying multiple large bottles which is secured to the neck of the bottle (U.S. Pat. No. 7,147,000). All of these devices are typically disposed of after purchase.

Other types of devices include those used to attach an object to the nail polish bottle, such as a clip to hold a plastic fingernail tip to a bottle or its cap (U.S. Pat. No. 7,185,452). Another device holds a disposable razor to a bottle of shaving cream (U.S. Pat. No. 4,320,832). Both devices are merely for storage of two different items together.

What is needed is a device that may be used to securely hold the bottles for storage and display, and also enables the attachment of an informational card. This invention is a device that secures together multiple bottle-like containers for display and storage, such as fingernail lacquer bottles. The bottles are secured by the resilient arms of the device, which apply force to each bottle individually. The resilient arms are attached to a central section which acts as an anchor and are equipped with catches to secure and attach an informational card, accompanied by a tab for the lining up of the bottles.

### BRIEF SUMMARY OF THE INVENTION

The present invention consists of several features combined into one unit which provides a product and method for the storage and display of fingernail lacquer, fingernail gel, or treatment bottles by clipping them together. The invention is a clip with two resilient arms, for grasping and linking two objects, preferably cylindrical fingernail lacquer bottles, which are attached to a central anchor section. The invention is a device for protecting and securing together two bottles by the application of a small lateral force by the holding resilient arms. The lateral force is applied to the bottle by resistance in the arms of the clips. The invention further provides for attachment points on the clip to hold in place an informative card and tabs on the resilient arms for positioning of the bottles in the clip.

The above brief description of the invention is intended to be illustrative and not limiting. Any feature or combination of features described herein are included within the scope of the present invention, provided that the features included in any such combination are not mutually inconsistent as will be apparent from the context, this specification, and the knowledge of one of ordinary skill in the art.

### BRIEF DESCRIPTION OF THE DRAWINGS

FIG. 1 is a front perspective view of the preferred embodiment of the resilient clip.

FIG. 2 is a back perspective view of the preferred embodiment of the resilient clip of FIG. 1.

FIG. 3 is a top view of the preferred embodiment of FIG. 1.

FIG. 4 is a top view showing a bottle positioned within the preferred embodiment of FIG. 1.

FIG. 5 illustrates, in perspective view from the back, a variation of the first preferred embodiment for the clip of FIG. 2.

FIG. 6 illustrates, in perspective view from the back, a variation of the first preferred embodiment for the clip of FIG. 2.

FIG. 7 is a back view showing a bottle positioned within the preferred embodiment of FIG. 1.

FIG. 8 is a front perspective view showing an informational card positioned within the preferred embodiment of FIG. 1.

FIG. 9 is a back perspective view showing an informational card positioned within the preferred embodiment of FIG. 1.

### DETAILED DESCRIPTION OF THE INVENTION

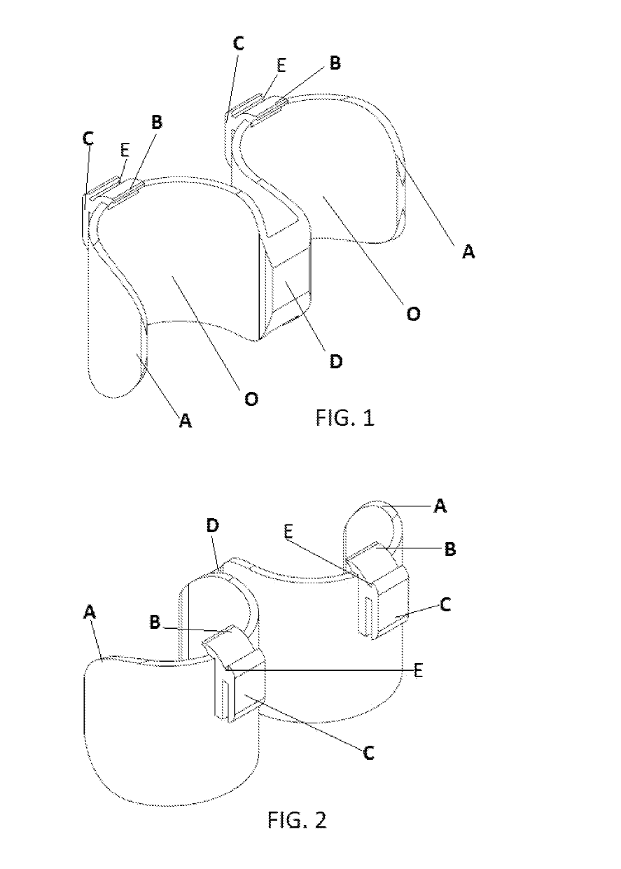

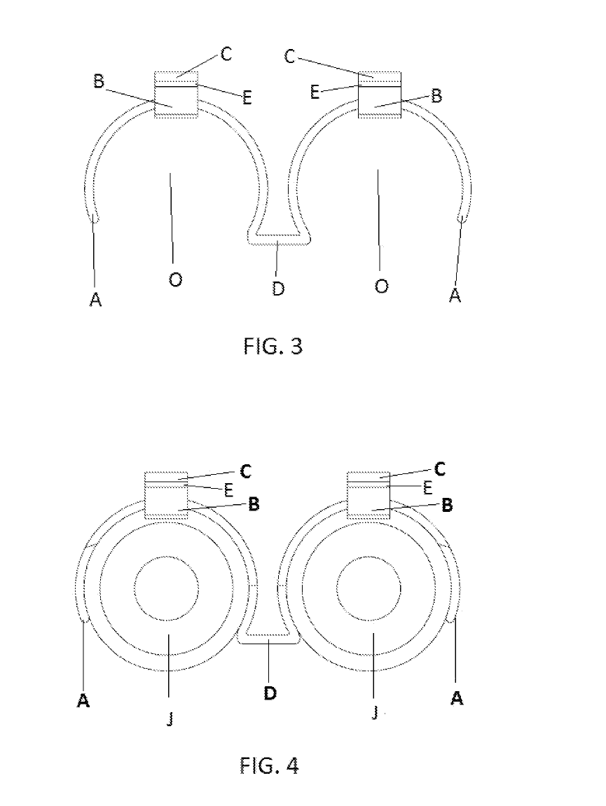

The fingernail lacquer bottle clip of the present invention comprises a single component, indicated generally by figures FIG. 1 through FIG. 4, which is comprised of a rigid material with sufficient flexibility to allow the resilient arm (A) to expand and accommodate a container (J). Each of the two mirrored resilient clip arms (A) are anchored to a central section (D) with each resilient arm (A) positioned in a way as not to obstruct the opening of other resilient arm (A), and which are not impinged by the central section (D).

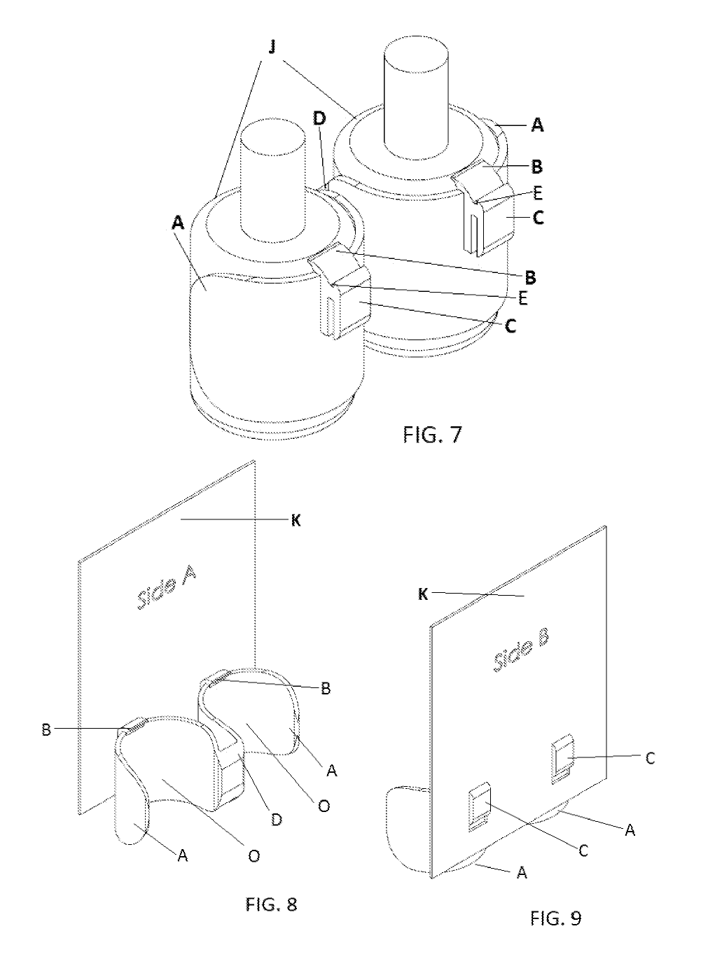

The resilient arm (A) is a curved feature with a radius slightly smaller than the intended container (J) with sufficient flexibility to securely hold container (J), as seen in FIG. 4 and FIG. 7, and an arc length sufficient to secure the container (J), yet still allow the container (J) to be removed with force above a minimum threshold determined by the material, wall thickness, resilient clip height, and the aforementioned arc length.

On the resilient clip arm (A) is a tab (B) which acts to position the inserted container within the cavity (O) created by the resilient clip arm (A). The tab (B) is affixed to the outer edge of the resilient arm (A), tangential to the curve of the resilient clip arm (A) and protrudes above the top plane of the arm (A). The shape and size of the tab is designed to neatly fit the top of the intended container (J), as illustrated in figure FIG. 7.

Adjacent to the tab (B) is a free hanging vertical wall attachment point (C) between which is a groove (E) for alignment and securing of an informational sheet (K) preventing the informational card (K) from tilting, as illustrated in FIG. 8 and FIG. 9,

Looking at FIG. 4 and FIG. 7, fingernail lacquer bottles (J) are present in the cavity (O) created by the flexible resilient arms (A) which are shown to be grasping the bottles (J) with tab (B) providing a positive stop ensuring each identical bottle (J) positioned at the same height when inserted into the fingernail lacquer bottle clip.

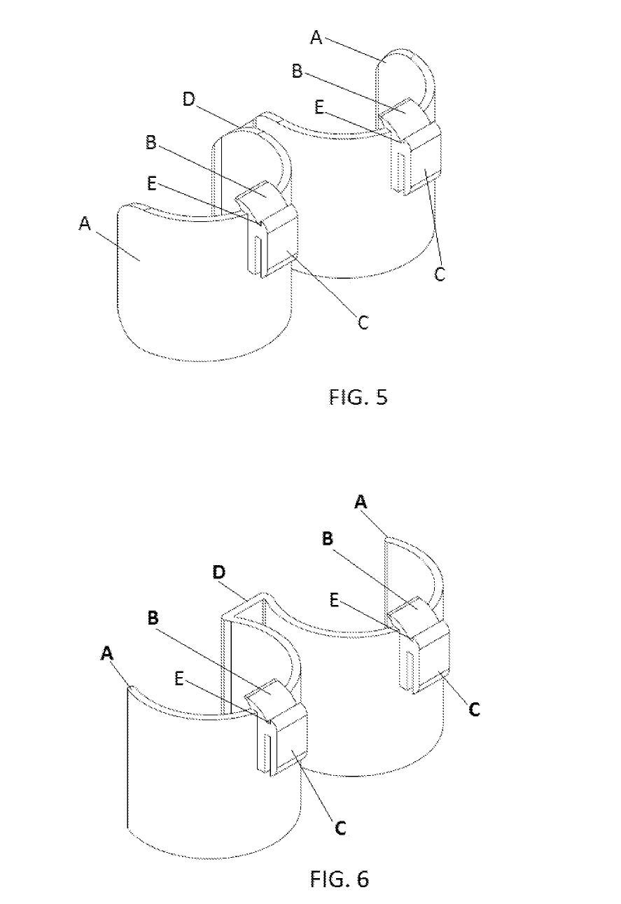

FIG. 5 and FIG. 6 provide an example of the differing shapes of the ends of the flexible resilient arms (A).

The present invention, as illustrated in figures FIG. 1 through FIG. 9, is a resilient clip that can be made of any rigid material—plastic, metal, or wood—so long as it is thin enough such that it can be flexed without breaking and rigid enough to grip the object that the clip is sized for. If made of plastic, the device can be either injection molded, milled, 3-dimentional printed, or any other additive or subtractive method appropriate for the type of plastic used. If made of metal, it can be stamped and cast then formed, milled, or 3D printed. If made of wood, it can be milled or shaped, either from whole wood or composite. The preferred method of manufacture is injection molding using a thermoplastic. The clip can be made of varying colors and finishes.

What is claimed is:

1. A resilient clip comprising:
a central section that acts as an anchor for two circular resilient arms with openings that are oriented in such a way as to not obstruct each other and is not impinged by the central section.

2. The resilient clip in claim 1, wherein the height and opening size is sufficient to allow the resilient arm of the resilient clip to flex and grasp an intended object.

3. The resilient clip in claim 1, wherein at the top of each resilient arm is a tab that protrudes into the cavity created by the arm and acts to position the resilient clip and prevent it from sliding down the grasped object.

4. The resilient clip in claim 1, wherein on the back of each resilient arm are attachment points which act to secure an information sheet.

5. The resilient clip in claim 1, wherein on the top of each resilient arm between the tab and the attachment points is a groove for the positioning and securing of the information sheet.
